(19) United States
(12) Patent Application Publication
(10) Pub. No.: US 2004/0075197 A1
(43) Pub. Date: Apr. 22, 2004

(54) Method for rapid forming of a ceramic green part

(76) Inventor: Hwa-Hsing Tang, Yunghe City (TW)

Correspondence Address: TROXELL LAW OFFICE PLLC, 5205 Leesburg Pike, Suite 1404, Falls Church, VA, 22041, US

(21) Appl. No.: 10/274,138

(22) Filed: Oct. 21, 2002

(51) Int. Cl. H05B 6/00; B29C 67/00; B29C 35/08

(52) U.S. Cl. 264/430; 264/497; 264/482; 264/492

(57) ABSTRACT

This invention provides a process for rapid forming of a ceramic green part. It is based upon an effect, that nano-scaled oxide colloid can be gelled by drying. Slurry can be obtained by mixing the oxide colloid with ceramic powder and dissolved agent. After paving a slurry film on a platform, a focused high-energy beam scans over the surface of said slurry film; the irradiated portion will be dried and build a two-dimensional (2-D) pattern. In addition, another slurry film is paved on the finished 2-D pattern layer. The high-energy beam scans once more on slurry film locally; another 2-D pattern is built. This built pattern can be connected with the pattern beneath it. After multiple repetitions of this procedure a three-dimensional (3-D) part can be formed. Because gelling is an irreversible reaction, the gelled portion of slurry won't be dissolved in water. Therefore, the non-gelled slurry can be separated from the gelled ceramic green part by flushing.

### BACKGROUND OF THE INVENTION

1. Field of the Invention

This invention pertains to a method for rapid fabricating ceramic green parts based upon irreversible gelling effect of oxide sol.

2. Description of the Prior Art

Rapid prototyping originated in 1984 and has been subsequently commercialized since 1988. Due to a fast development of the computer-aided design and the manufacture technology, its market grows up with a rate of 58% every year in the last decade. During this period, many rapid prototyping technologies were developed. For those dedicate to fabricate ceramic green parts can be grouped into five categories.

1. Liquid state resin can be polymerized and can be converted into solid state by the exposure of the ultraviolet light. This technology is known as Stereo Lithography (U.S. Pat. No. 4,575,330 to Charles Hull, 1986). Professor Brady of University of Michigan described a process based on the Stereo Lithography method that used ceramic resin (a mixture of ceramic powder and light-sensitive resin) as a raw material and exposed such material under a directed ultraviolet light in order to solidify said liquid state resin. The solidified resin bonded ceramic powder to form ceramic green parts. In addition, the patent of Halloran et al. illustrated a similar process which used 40%˜80% ceramic powder in ceramic resin (U.S. Pat. No. 6,117,612).

2. Selective Laser Sintering (SLS, U.S. Pat. No. 4,863,538, September, 1989, Deckard) was invented in 1986, and has been subsequently commercialized by DTM Company. The SLS technology can be applied to various materials to fabricate 3-D RP work pieces as long as the material is in form of powder. At present, the SLS technology comprises the steps of coating ceramic powder with resin, melting the resin with a laser so that the resin acts as a bonding agent of the ceramic powder for forming a ceramic green part and then processing the ceramic green part with a conventional ceramic sintering technology to obtain a final ceramic work piece. A typical material used in the SLS process is polymer coated aluminum oxide.

3. Fused Deposition Modeling (FDM) involves a step of fusing a filament to a temperature above melting point. Stratasys Inc. has developed commercial systems for this process. Professor Agarwala of Center for Ceramic Research at Rutgers University mixed ceramic powder and organic binder together to form a filament and then fabricated a ceramic green part with this ceramic-polymer filament by a FDM machine.

4. Sachs et al. of Massachusetts Institute of Technology invented Three Dimensional Printing (U.S. Pat. No. 5,204,055). In this process binding agent was selectively spurted out in a similar way of ink jet technology but onto a designated powder material. If the said powder material is ceramic, a ceramic green part can be formed by this technology.

5. Laminated Object Manufacturing (LOM, U.S. Pat. No. 4,752,353, Feygin) describes a technology that utilizes a laser beam to cut a cross sections of a 3-D object from a thin slice of solid material, then glue these thin slices one on top of the other to form a 3-D object. Such a process can be implemented on materials including paper and sheet metal. Ceramic sheet can be made from ceramic powder and polymer binder.

The above-mentioned five technologies are all related to the forming of ceramic green parts by bonding ceramic powder with organic binder. Because the added organic binder must be burnt out during sintering, not only many pores will be left but also uncontrollable shrinkage and deformation is the result. Also the released hazardous gases may damage human body and pollute the environment.

Thus the above-mentioned present skills are not perfect, and need to be improved.

In order to improve the defects of the above-mentioned methods the inventor have after year's research finally successfully found this method for rapid fabricating ceramic green part.

### SUMMARY OF THE INVENTION

The purpose of the present invention is to provide a method, which can rapid fabricate green parts of almost 100% ceramic material. Because precursor does not contain organic binders, there are no hazardous gases during processing.

The principle of the present invention is based on an irreversible gelling effect of oxide sol, for example silica sol, alumina sol, etc., while heating. Oxide sol is a compound of water and nano-scaled oxide particles. When a mixture of ceramic powders and oxide sol is heated, the moisture of the mixture evaporate, the nano-scaled oxide particles bind the surrounding ceramic powders closely if the concentration of oxide sol is above a critical gelling point. This phenomenon is called gelling effect. Because the resulted three-dimensional reticulate structure is insoluble in water, this reaction is irreversible. If a high power energy beam scans over a ceramic mixture containing oxide sol, the scanned portion will be converted to water insoluble reticulate structure, the other portion can be flushed by water. These effects can be used to fabricate ceramic green parts layer by layer.

This invention provides a method based on above-mentioned principle for fabricating ceramic green parts. The process according to the present invention begins by mixing inorganic oxide sol and dissolving agent in ceramic powder to form slurry. After continuous blending this slurry is paved on a platform to form a thin uniform slurry layer by mechanical means. Afterward the thin slurry layer is scanned by a high-power energy beam (ex: CO₂ laser beam), the moisture of the ceramic mixture in scanned areas evaporates, then the nano-scaled oxide bind the ceramic powders to a water insoluble reticulate structure due to the irreversible gelling effect. An arbitrary 2-D shape can be fabricated by controlling the scan path. Repeating the same steps, the later made second layer can be bound to the former made first layer due to gelling effect. Thus, a three-dimensional configuration is formed layer by layer. The portion of the slurry, where has not been scanned, can maintain in a liquid state due to absence of gelling effect and can be flushed out with water. According to this process a ceramic green part can be rapidly fabricated.

Comparing the present invention with the prior technologies, it becomes evident that the present invention has following features, by which the present invention's originality and progress over prior art can be revealed.

1. The principle and material type of present invention are obviously different from prior skill.

2. This invention makes use of raw materials that are abundant on the earth, safe, nontoxic, recyclable and have low costs.

3. The ingredients of the finished part according to present invention can reach 100% ceramic. This part is able to sustain in high temperature.

### BRIEF DESCRIPTION OF THE DRAWINGS

The drawings disclose an illustrative embodiment of the present invention, which serves to exemplify the various advantages and objects hereof, and are as follows:

FIG. 1A to FIG. 1F show flow charts of the process according to the present invention.

### DETAILED DESCRIPTION OF THE PREFERRED EMBODIMENT

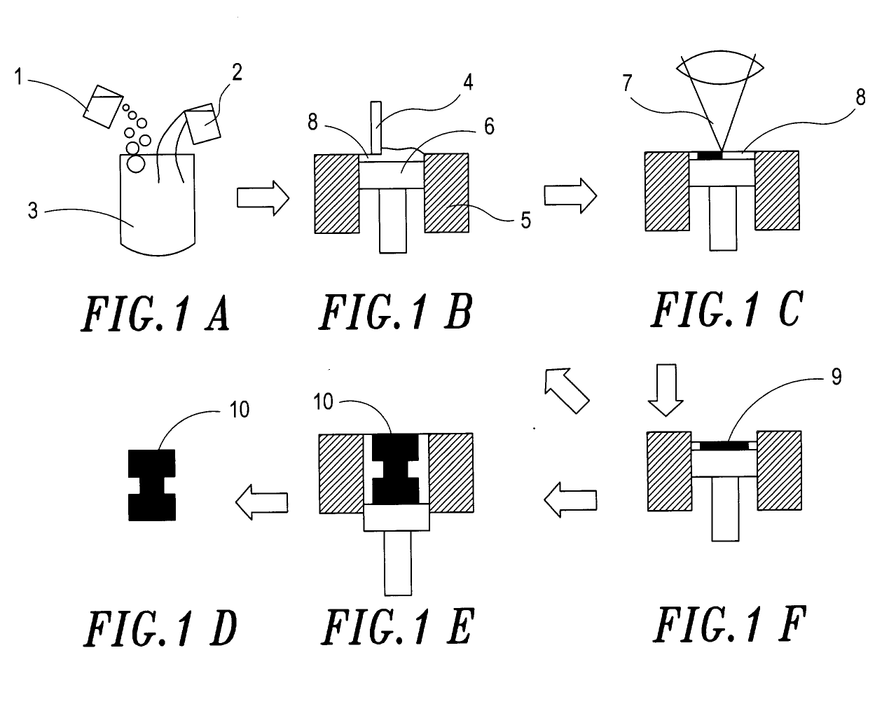

Please see FIG. 1A to FIG. 1F. They are diagrams of process flow chart according to the present invention. The process contains four main steps: preparation of slurry, paving thin slurry layers, transferring a portion of the thin slurry layer to a green ceramic cross section of a 3D workpiece by scanning with a high-power energy beam, removing un-gelled slurry to obtain a green ceramic workpiece.

The details of the process are described in following:

The First Step: Preparation of Slurry

Referring to FIG. 1A, ceramic powder 1 is placed in the left cup, the right cup contains oxide sol 2, the under bigger cup contains slurry 3 that is a mixture of ceramic powder 1 and oxide sol 2. Ceramic powder can be either a single ceramic ingredient such as aluminum oxide, silicon oxide, zirconia oxide, and other oxides or a mixture of two or more above ceramic ingredients. Nano-scaled oxide sol can be silica sol, alumina sol, zirconia sol, and other sols, which can be gelled by scanning with a high-power energy beam and then connect surrounding ceramic powder. The liquid in sol can be water or other liquids. Mixing ceramic powder and oxide sol with a suitable ratio can make slurry. Experiments show that a proportion of 60 weight percent silicon oxide (of 79 μm˜53 μm particle size) to 40 weight percent silica sol can make high quality slurry.

The Second Step: Paving Thin Slurry Layers

Referring to FIG. 1B, paving the slurry 3 on the concave space formed between elevating platform 6 and paving platform 5.

A servomotor can control the motion of elevating platform 6. The elevating platform 6 is lowered to accommodate the next thin slurry layer. After the slurry is put into concave space, blade 4 scrapes the slurry, which piles up over the working level, off along the paving platform. The slurry surface level then equals to the working level. Thus, a control of the thin slurry layer 8 can be accurately done by properly determining the lowered depth of the elevating platform.

The Third Step: Scanning the Thin Slurry Layer with a High-Power Energy Beam to Form a Ceramic Green Cross-Section.

As shown in FIG. 1C, a high-power energy beam 7, preferably a laser scans the thin slurry layer 8. The thin slurry surface absorbs energy and its temperature is raised immediately. Via heat transfer energy flows downwards. A certain depth of the material is gelled because absorbed water is evaporated upon heating. Thus, the ceramic powders in scanned area are bonded together. Therefore, by modulating relevant parameters of the gelling process the gelling depth can be varied. By gelling effect a series of overlapping points can form a line, a series of overlapping lines can form a plane.

The main input parameters for modulating the scanning process are power and scanning speed. The power required by the process of the present invention depends on the efficiency to convert the energy of a high-power energy beam to heat energy. The absorption rate of the ceramic powder upon a CO₂ laser beam is about 90% or above, so it is relatively easy to elevate the temperature of water and cause water to evaporate as soon as CO₂ laser beam is impinged on the thin slurry layer. The temperature of process is below 100° C. Experiments have shown that the silicon oxide slurry can be gelled by a relatively low power, 10W, and a relatively quick scanning speed, 300 mm/sec.

The movements of a high-power energy beam can be accomplished by using an X-Y table or by using a Mirror Scan Head. Both technologies have become fairly mature nowadays and served a wide range of applications including laser engraving and marking. Another positioning system is called Dynamic Micro-mirror Device (DMD) supplied by Texas Instrument, can also offer the scanning function in present invention. DMD is also called dynamic mask. By input of a series of digital positioning signals, the cross-section can be shown at the same time. So, exposing the total scanning area at a short exposing time is possible. The time for scanning process can be shortened significantly if this system is applied.

After a layer of the green ceramic cross-section 9 has been formed, the elevating platform 6 will be lowered with a distance of thin slurry layer thickness, and the slurry will be paved into the concave space between the elevating platform 6 and the paving platform 5. Repeating steps (2) and (3), paving a thin slurry layer and then scanning the thin slurry layer with a high-power energy beam, a series of green ceramic cross-sections can be formed. Applying suitable laser power and scanning speed, the formed ceramic green cross-section can be bond together, as shown in FIG. 1(E). Thus, a series of overlapping planes form a 3-D green ceramic workpiece 10.

Experiments have shown that a layer thickness of 0.05 mm can be built, the workpiece is 10 mm high, and 200 sliced layers are fabricated by repeating steps (2) and (3) 200 times.

The Fourth Step: Removing Un-Gelling Slurry

As shown in FIG. 1E, the portion far apart from solidified portion doesn't connect the workpiece and can be separated automatically from the workpiece 10, but the portion near the solidified portion is more or less dried by heat, the slurry in this portion is more difficult to drain. After moving the workpiece out of platform and washing the remaining slurry away from the surface of the workpiece by water jet or by soaking, and shaking it slowly in water, a ceramic green workpiece can be obtained.

Experiment

According to the main steps from FIG. 1A to FIG. 1F, the preparation of slurry was done by mixing silicon oxide powder with silica sol in a proportion of 6:4. By continuous blending homogeneous slurry could be formed. Afterwards, the slurry was paved in the concave space (see FIG. 1B) between elevating platform and paving platform. Using a scrape to scrape the slurry along the paving platform, the height of the slurry surface would equal the height of the paving platform surface.

Afterwards, a laser beam scanned the slurry surface via manipulating the X-Y mirror of a scan head according to the path program of a cross-section of a 3D workpiece. The scanned slurry was gelled by heat and became to a solid state. The solidified portion did not dissolve in water, could keep its form and strength.

Subsequent to the formation of a cross section, the elevating platform lowered to a distance, which equaled to the thickness of a slurry layer (0.1 mm). Repeating these two steps, paving slurry thin films and gelling by laser scan until all cross-sections were finished.

Finally, removing the workpiece and washing away the slurry from the surface of it by water, a 3D workpiece could be obtained.

Features

Comparing the present invention with the prior technology, it becomes evident that the present invention has following features:

1. The principle and material type of present invention are obviously different from prior skill.

The SLA applies the principle of polymerization of an organic photo curable resin. A polymerization is initiated by irradiating of a chemical ultraviolet light on the photo curable resin. SLS process applies the principle of melting of a solid powder. The melting of powder happens when a physical infrared ray is focused on the powder surface. The principle of the present invention is according to the polymerization of an inorganic nano-scaled oxide sol. Impinging of a physical infrared ray on oxide sol can induce heat to evaporate the liquid in oxide sol, and enhances a polymerization. Furthermore, SLA process applies liquid photo curable resin, but the present process uses slurry, which is a mixture of solid ceramic powder and liquid water, and the solid ceramic powder can has a particle size from several nm to 100 μm.

2. This invention makes use of raw materials that are abundant on the earth, safe, nontoxic, recyclable and have low costs.

The ceramic powders used in this process such as silica powder and silica sol are low cost materials, because they are abundant in reserve on earth, have a mature manufacturing process, and have many providers.

The present invention uses nano-scaled oxide sol as a binder and ceramic powders as main raw materials. They are nontoxic and bland, and don't evaporate any noxious gas against human body and the environment while heating. The main constituents of earth are oxides. Once the raw material and product of this process is discard on earth, the environment would not be polluted. Moreover they are recyclable.

3. The ingredients of the finished part according to the present invention can reach 100% ceramic. This part is able to sustain in high temperature.

In other RP processes, the material comprises a photo curable resin, organic binder, or other non-ceramic compositions. So far there is no RP process, which uses 100% ceramic material. However, the present invention uses an inorganic binder such as nano-scaled oxide sol to mix with ceramic powders. After evaporating the moisture of the mixture by a high-power energy beam scanning, the nano-scaled ceramic particles bind to micro-scaled ceramic powders due to polymerization. For example, mixing silica powders with nano-scaled silica sol can obtain a product of a 100% pure silica green part. A high pure workpiece can usually raise the mechanical and electrical property; especially it can sustain in high temperature.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method for fabricating of a green ceramic workpiece by applying irreversible gelling effect of nano-scaled oxide sol, comprising the steps of:
(1) mixing and blending ceramic powder and nano-scaled oxide sol together to form slurry;
(2) forming a thin slurry layer on a specified surface by a suitable manner;
(3) scanning the thin slurry layer with a high-power energy beam by a suitable manner along a pre-determined path; in the scanned portion, a gelling effect will be activated, ceramic powders bonding together locally by heat and producing a two-dimensional thin cross section of the green ceramic workpiece; after that, lowering the platform for a distance of thickness of a thin slurry layer;
(4) repeating steps (2) and (3) for a pre-determined times until a three dimensional ceramic workpiece is fabricated based on a pre-determined number of thin green ceramic layers that are bonded together by the high-power energy beam of step (3); and
(5) removing the portion of un-gelled slurry that is not scanned by the high-power energy beam with a proper mean and thus producing a ceramic green workpiece.

2. The method as claimed in claim 1, wherein the ceramic powder comprises either a single ceramic ingredient or a mixture of two or more ingredients.

3. The method as claimed in claim 1, wherein the single ceramic ingredient comprises aluminum oxide, silicon oxide, zirconia oxide, or other oxides, all of which are in powder form.

4. The method as claimed in claim 1, wherein the nano-scaled oxide sol comprises silica sol, alumina sol, zirconia sol, or other oxide sol, all of which are nano-scaled.

5. The method as claimed in claim 1, wherein the thin slurry layer is formed on a specified surface by scrape coating.

6. The method as claimed in claim 1, wherein the thin slurry layer is formed on a specified surface by spin coating.

7. The method as claimed in claim 1, wherein the high-power energy beam is an infrared beam.

8. The method as claimed in claim 1, wherein the high-power energy beam is a laser beam.

9. The method as claimed in claim 1, wherein the high-power energy beam is a CO2 laser beam.

10. The method as claimed in claim 1, wherein the scanning manner is X-Y Table scanning.

11. The method as claimed in claim 1, wherein the scanning manner is selective digital micro-mirror device (DMD) scanning.

12. The method as claimed in claim 1, wherein the portion of un-gelled slurry that is not scanned by the high-power energy beam is removed by water jet washing.

13. The method as claimed in claim 1, wherein the portion of un-gelled slurry that is not scanned by the high-power energy beam is removed by soaking it slowly in water.
